(19) United States
(12) Patent Application Publication
(10) Pub. No.: US 2022/0039403 A1
(43) Pub. Date: Feb. 10, 2022

(54) Dry muffin and pancake mix

(71) Applicant: Katrina D Stanley, Broken Arrow, OK (US)

(72) Inventor: Katrina D Stanley, Broken Arrow, OK (US)

(21) Appl. No.: 16/986,806

(22) Filed: Aug. 6, 2020

(51) Int. Cl. A21D 10/00; A21D 2/18; A21D 2/36; A21D 2/14; A21D 2/02; A21D 13/066; A21D 13/043

(52) U.S. Cl. CPC A21D 10/005; A21D 2/186; A21D 2/366; A21D 13/043; A21D 2/145; A21D 2/02; A21D 13/066; A21D 2/364

(57) ABSTRACT

Ingredients include tapioca starch, tigernut flour, and cassava flour OR almond flour, fruit power, or dried fruit, or spices of ginger, nutmeg, cloves, or cocoa powder or chocolate chips, and/or tree nuts, cream of tartar, baking soda, sea salt, cinnamon spice, pure powder vanilla, pure V50% mongroside monk fruit powder.

For each mix, start with tapioca starch that serves as a “binder” for the grain free flours. Tigernut flour is added to each mix to prevent finished product from being gummy and not bready. Add Cassava flour or Almond flour to create two different mixes with carbohydrate alternatives.

To each mix, add cream of tartar, baking soda, sea salt, pure powdered vanilla (no fillers), cinnamon spice (do not add to chocolate mix), V50% mongroside powered monk fruit. Add desired dried fruit powder, dried fruit, or spices to include cloves, ginger and nutmeg, or cocoa powder, and/or chocolate chips, and/or tree nuts or no nuts.

Ingredients include tapioca starch, tigernut flour, and cassava flour, OR almond flour, and fruit power, dried fruit or spices of ginger, nutmeg, cloves or cocoa powder or chocolate chips, and/or tree nuts, cream of tartar, baking soda, powdered cinnamon spice, pure, powder vanilla, pure V50% mongroside monk fruit. The dry mix is gluten free, grain free, dairy free, no corn, no added sugar, no artificial sweeteners, no preservatives, soy and lecithin free, maltitol-free, sorbitol-free, xylitol-free, erythritol-free, and isomalt-free that satisfies both the Paleo and Keto friendly dietary preferences. I call these baking mixes, as they create muffins, pancakes and desserts, such as toppings for fruit cobblers. Since this is a dry baking mix, I add only dry ingredients to each mix, with instructions on each package for the customer to add the exact type and amount of “wet” ingredients to each variation of the mixes before baking to achieve the desired finished product—whether the baking mix will be prepared as muffins, pancakes or cobbler topping.

For each mix, start with a measured amount of tapioca starch, which is a starch that is derived from the cassava root plant, which is not a grain and is naturally gluten free. Tapioca starch serves as a “binder” for the flours in this dry mix. To the tapioca starch, add a measured amount of tigernut flour. Tigernut flour is derived from a small root vegetable found in Southern Europe, Africa, Madagascar and Middle East, which is not a nut, or a grain and is naturally gluten free. Tigernuts are ground into a flour. I add tigernut flour to all variations of my muffin/pancake/dessert mix to add a soft, bready-type texture that helps “hold up” the texture and keep it from being gummy after cooking.

To this mixture, add either cassava flour OR almond flour to create a flour “base.” Cassava flour is made from the cassava root and is not a grain, and is also naturally gluten free. Cassava flour is a very fine flour, giving a soft, bready texture. I use cassava flour in many variations of these dry mixes for those who are sensitive or allergic to tree nuts.

OR, to the Tapioca and tigernut flour mixture, I add almond flour. The almond flour I use is made from blanched, ground almonds, which are a tree nuts, they are not a grain and they are naturally gluten free. The almond flour gives the muffin/pancake/dessert mix a chewy and slightly coarser texture than that of the cassava flour.

Both variations, using the cassava flour OR using almond flour combined with the tapioca and tigernut flour create a “base” flour mixture to which the following ingredients are added to create two different but similar muffin/pancake/dessert mixes, according to the specific ingredients that are added to create different variations. I do not use any other type of flours in my dry mixes.

To each of the respective “base” flour mixtures, either cassava flour base mix OR almond flour base mix, I then add a measured amount of cream of tartar and a measured amount of baking soda. These act as leavening agents causing the muffins and/or pancakes and/or desserts to rise, which remain inactive in the mixes until liquid is added to the mixes. Then, I add a sea salt. This adds to the leavening ability of the cream of tartar and baking soda, but mostly enhances the flavor of the overall baking mix.

Next, to each of the respective baking mixes, I add a measured amount of pure, powder vanilla and cinnamon spice. This is added to enhance the flavor of each baking mix.

Next, to each of the respective baking mixes, I add a pure, v50% mongroside monk fruit. Monk fruit is a natural sweetener found in the plant called monk fruit, which is found in China. I do not use a monk fruit blend. Nothing is blended into the monk fruit I use, whether to change the sweetening quality, amount used or otherwise. The V factor determines the level of purity and sweetness of the monk fruit. The higher the percent of mongrosides, the sweeter and less yellow the color of the monk fruit. Likewise, the less percent of mongrosides, the less sweet and more yellow the color of the monk fruit. I prefer the V50% mongrosides for its taste and sweetening quality for my dry baking mixes. Monk fruit has no calories and has no glycemic effect on blood sugars. Thus, I state accurately on my product “No sugar added.”

Next, to each respective baking mix, I add either fruit powder or dried fruit, or a measured amount of spices to include cloves, ginger and nutmeg, or cocoa powder and/or chocolate chips and/or tree nuts, as well as no nuts to each variation.

1. Gluten Free

2. Grain Free

3. Dairy Free
